(19) United States
(12) Patent Application Publication
(10) Pub. No.: US 2011/0192861 A1
(43) Pub. Date: Aug. 11, 2011

(54) MEDICAL GLOVE DISPENSING DEVICE AND ASSEMBLY AND METHOD OF DISPENSING MEDICAL GLOVES

(76) Inventors: Mark BATES, Westwood, MA (US); Chul Min KANG, Coral Springs, FL (US)

(21) Appl. No.: 13/023,019

(22) Filed: Feb. 8, 2011

Related U.S. Application Data
(60) Provisional application No. 61/303,504, filed on Feb. 11, 2010.

(51) Int. Cl. B65D 83/00; B65G 59/00

(52) U.S. Cl. 221/1; 221/124; 221/125

(57) ABSTRACT

A medical glove dispensing device includes a panel having a plurality of differently sized ports, wherein each of the ports is sized to provide indicia about a size of a medical glove adapted to be disposed behind and dispensed through the port. A holder is disposed adjacent the panel and provides a plurality of storage spaces sized and adapted to support a plurality of medical glove containers holding differently sized medical gloves. The plurality of storage spaces are aligned respectively with the plurality of ports, with each of the storage spaces having substantially the same width. A medical glove dispensing assembly, and a method of dispensing medical gloves, are also provided.

This application claims the benefit of U.S. Provisional Application Ser. No. 61/303,504, filed Feb. 11, 2010, the entire disclosure of which is hereby incorporated herein by reference.

### FIELD OF THE INVENTION

The present invention relates generally to medical glove dispensing device and assembly, and to a method of dispensing medical gloves from such a device.

### BACKGROUND

Medical gloves, including for example sterilized latex or synthetic gloves, are commonly used in healthcare environments to prevent the spread of infections. The gloves provide an interface that protects both the patient and the healthcare provider. As such, healthcare environments, including for example and without limitation hospitals, doctor's offices, nursing homes and the like, are supplied with medical gloves in various areas where such interfaces transpire. Typically, medical gloves are available in different sizes, for example large, medium and small. In this way, the healthcare provider can select the glove most suitable for their hand size, thereby maximizing the functionality of their hands while providing the requisite protection. Often, gloves of different sizes are provided in containers, such as boxes, having the same size, which are then stored together in a drawer or cabinet.

In some instances, the healthcare provider may need to access and don medical gloves quickly. This process may be impeded if the healthcare provider must first discern the proper size by studying the containers for the proper size indicia. Alternatively, the boxes of gloves may be stored in dispensers having the same size access openings, making it more difficult for a user with large hands to access the gloves.

### SUMMARY

The present invention is defined by the following claims, and nothing in this section should be considered to be a limitation on those claims.

In one aspect, one embodiment of a medical glove dispensing device includes a panel having a plurality of differently sized ports, wherein each of the ports is sized to provide indicia about a size of a medical glove adapted to be disposed behind and dispensed through the port. A holder is disposed adjacent the panel and provides a plurality of storage spaces sized and adapted to support a plurality of medical glove containers holding differently sized medical gloves. The plurality of storage spaces are aligned respectively with the plurality of ports, with each of the storage spaces having substantially the same width.

In another aspect, a medical glove dispensing assembly includes a plurality of medical glove containers each holding a plurality of medical gloves, wherein each of the plurality of medical glove containers holds a different size medical glove. Each of the plurality of medical glove containers has an opening through which the medical gloves are dispensed. A holder provides a plurality of storage spaces sized to support the plurality of medical glove containers, with the storage spaces each having the same width. The plurality of medical glove containers is disposed in the plurality of storage spaces. A panel having a plurality of differently sized ports is positioned adjacent the holder such that the plurality of storage spaces and the openings of the plurality of medical glove containers are aligned respectively with the plurality of ports. Each of the ports is sized to provide indicia about the size of the medical glove in the medical glove container positioned behind the port.

In yet another aspect, a method of dispensing medical gloves include positioning a plurality of medical glove containers in a plurality of storage spaces provided by a holder behind a panel. Each of the plurality of medical glove containers holds a plurality of medical gloves. Each of the plurality of medical glove containers holds a different size medical glove. The panel has a plurality of differently sized ports aligned respectively with the plurality of storage spaces, each having substantially the same width. Each of the ports is sized to provide indicia about the size of the medical gloves in the medical glove container positioned behind the port. The method further includes dispensing a medical glove from one of the plurality of medical glove containers through the port aligned with the medical glove container positioned in the storage space aligned with the port.

The various embodiments of the medical glove dispensing device and assembly, and methods for the use thereof, provide significant advantages over other dispensing devices and methods. For example and without limitation, the differently sized ports provide indicia to the healthcare provider about the size of the glove available through that port. In this way, the healthcare provider does not have to spend valuable time and effort to study the container to discern the size of the gloves disposed therein. In addition, the device provides for larger openings to be associated with larger gloves, and thereby provide better access for the corresponding larger hands of the healthcare provider seeking to access those gloves.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIG. 1 is a perspective view of one embodiment of wall unit for a healthcare facility.

FIG. 2 is an enlarged perspective view of a medical glove dispensing device in a dispensing configuration.

FIG. 3 is a perspective view of the medical glove dispensing device shown in FIG. 2 in a loading configuration.

FIG. 4 is an enlarged partial view of a holder with a biasing member.

FIG. 5 is an enlarged partial view of a rear corner of the dispensing device.

FIG. 6 is an illustration of three containers of differently sized medical gloves.

FIG. 7 is an alternative embodiment of a medical glove dispensing device.

FIG. 8 is a partial bottom view of the dispensing device.

### DETAILED DESCRIPTION OF THE PRESENTLY PREFERRED EMBODIMENTS

It should be understood that the term “plurality,” as used herein, means two or more. The term “coupled” means connected to or engaged with whether directly or indirectly, for example with an intervening member, and does not require the engagement to be fixed or permanent, although it may be fixed or permanent. The term “first,” “second,” and so on, as used herein are not meant to be assigned to a particular component so designated, but rather are simply referring to such components in the numerical order as addressed, meaning that a component designated as “first,” may later be a “second” such component, depending on the order in which it is referred. It should also be understood that designation of “first” and “second” does not necessarily mean that the two components or values so designated are different, meaning for example a first container may be the same as a second container, with each simply being applicable to different components of the same size and configuration.

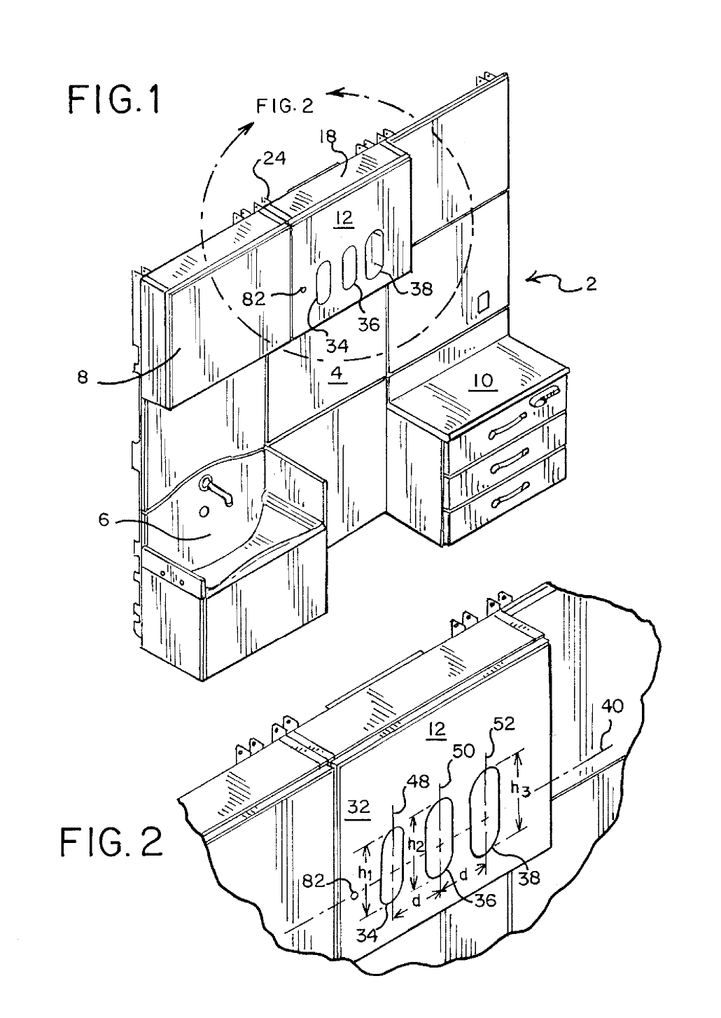

Referring to FIG. 1, a wall unit 2 configured for use in a healthcare facility is disclosed. The wall unit is further disclosed in U.S. Provisional Application, entitled Wall Mounted Assembly, and filed as application Ser. No. 61/303,510 on Feb. 11, 2010, the entire disclosure of which is hereby incorporated herein by reference. It should be understood that the term “healthcare facility” refers to any environment wherein a patient, whether human or animal, is capable of being treated or otherwise attended to, including hospitals (human and animal), clinics (temporary and permanent), schools, doctor's offices, nursing homes, ambulances, and the like. As shown in FIG. 1, the wall unit includes various components, such as tiles 4, a wash station 6, and storage units 8, 10.

In one embodiment, a medical glove dispensing device 12 is shown as including a cabinet having a rear panel 14, side walls 16 and upper and lower walls 18, 20 defining an interior space 22. In one embodiment, the rear panel is configured as a mounting panel, which is secured to infrastructure 24 behind the rear panel, for example with fasteners 26, adhesives, and the like, or combinations thereof. The cabinet may include one or more shelves 28. In one embodiment, additional storage is provided by extending a portion of the rear wall to form an auxiliary cavity 30 which may be disposed for example and without limitation in a space between the unit and an architectural wall, or in a space formed in the wall. Of course, it should be understood that the dispensing device may also be integrated into the permanent wall, or made portable, for example as a unit that can be carried or wheeled about.

Referring to FIGS. 1-3, the dispensing device includes a panel 32 having a plurality of differently sized ports 34, 36, 38. In one embodiment, the panel includes three ports corresponding to a small, medium and large size, although it should be understood that the panel may be configured with only two ports, or more than three ports. In one embodiment, the ports 34, 36, 38 each have a different height (h1, h2, h3), but have horizontal centerlines aligned along a horizontal axis 40. In this way, same-size containers of differently sized gloves 42, 44, 46, as shown in FIG. 6, will be aligned with the ports 34, 36, 38 when the containers are positioned behind the ports. In other embodiments, the ports may not be vertically aligned. It should be understood that in an alternative embodiment, the ports are vertically spaced, with the “height” thereof running horizontally from side-to-side. In addition, it should be understood that the containers may have different sizes, but are accommodated by the storage spaces of substantially the same sizes.

In one embodiment, the distance (d) between the vertical centerlines 48, 50, 52 of adjacent ports 34, 36, 38 is the same. In this way, same-size containers 42, 44, 46 of differently sized gloves, as shown in FIG. 6, will be aligned with the ports 34, 36, 38 when the containers are positioned behind the ports. In addition, if the containers are of different sizes, they may still be aligned with the ports.

In one embodiment, the shapes of the ports 34, 36, 38, which are different sizes, are generally the same. In this way, it should be understood that the terms “size” and “shape” refer to different characteristics, such that openings have the same shape may be different size and vice versa. For example, as shown in FIG. 2, the ports 34, 36, 38 each have an obround shape, albeit of different sizes. It should be understood that the shapes may have other configurations, including without limitation various polygonal shapes, including rectangular or square, diamond, etc., or may be round, oval, etc. In addition, it should be understood that the different openings may have different shapes.

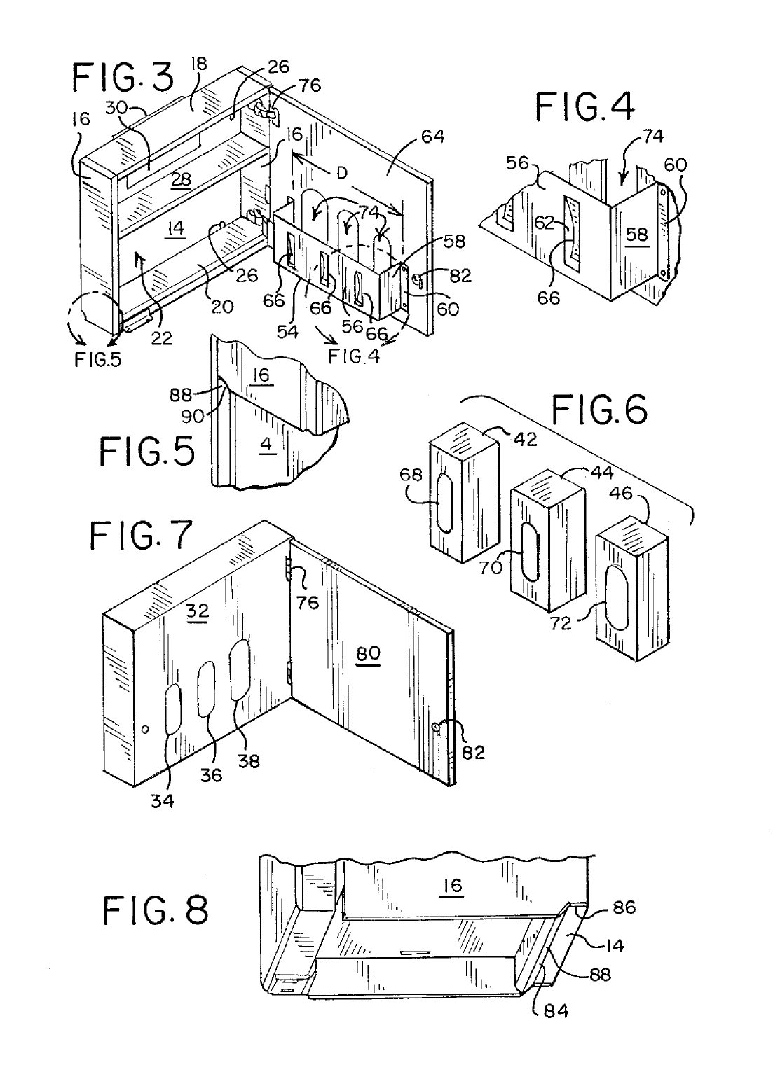

As shown in FIGS. 3 and 4, the dispensing device includes a holder 54. In one embodiment, the holder is configured as a bracket with a floor or shelf 62, a rear wall 56 and a pair of side walls 58, with the side walls having a flange 60 that is secured to a rear surface 64 of the panel, for example and without limitation fasteners, adhesive and the like, or combinations thereof. The floor 62 is disposed beneath the ports 34, 36, 38 such that containers 42, 44, 46 disposed in the holder, and in particular openings in the containers, are aligned with the ports. The rear wall 56 is spaced from the rear surface of the panel 64 so as to provide a space for the containers. The rear wall includes a plurality of biasing members 66 aligned respectively with the ports 34, 36, 38. The biasing members are configured in one embodiment as leaf springs. It should be understood that the biasing members may be configured as compression or tension springs, including coil springs, foam members, cantilevered springs, etc. The biasing members 66 engage a rear surface of the containers 42, 44, 46 and urge the containers toward the rear surface 64 of the panel, such that the containers are pressed against the panel and resist any entry forces exerted by the user as they grasp the gloves 68, 70, 72 held in the containers.

The holder defines a plurality of storage spaces 74 corresponding to the plurality of ports 34, 36, 38. For example, as shown in FIG. 3, the holder defines three storage spaces 74. The storage spaces may be virtual, i.e., without physical barriers separating the spaces, or may be further defined by walls (not shown). In one embodiment, the storage spaces 74 each have a width equal to approximately ⅓ D, or some proportionally lesser amount. It should be understood that the term “width” as used herein may be measured horizontally (as shown) or vertically, for example in an embodiment where the containers and ports are vertically spaced and aligned.

Referring to FIGS. 2 and 3, the panel 32 is moveably connected to the storage case, for example by connecting the panel to a side wall 16 with a pair of hinges 76. The panel 32 is moveable from a dispensing position (FIG. 2), wherein the panel is closed and the containers are not accessible, to a loading position (FIG. 3), wherein the containers may be accessed, for example to remove and replace empty containers. The storage case may be configured to hold additional containers of gloves, for example and without limitation by storing them on the upper shelf or in the auxiliary storage cavity. In one embodiment, the dispensing device is provided with a lock 82 that is actuatable between a locked position and an unlocked position. In the locked position, the lock secures the panel in the dispensing position so as to prevent tampering or movement of the containers. In the unlocked position, the panel can be moved to the loading position.

Referring to FIG. 7, an alternative embodiment of the dispensing device includes a cover panel 80. The cover panel can be moved from an open position, wherein a panel 32 having the ports 34, 36, 38 is exposed, to a closed position, wherein the cover panel 80 covers the ports. The cover panel preferably includes a lock 82, which can be actuated to lock the cover panel in the closed position. In this way, the cover panel protects the containers, and prevents them from being contaminated or tampered with in unsecure, high-traffic areas, such as hall ways or other public spaces.

Referring to FIGS. 5 and 8, a lower edge 86 of the rear panel 15, and the rear corners 88 of the side walls 16, each have a bottom surface 88 that transitions forwardly and downwardly. The lower edge and rear corner mate with an upper edge 90 of an underlying tile 4, which has an upper surface that also transitions forwardly and downwardly. In this way, the interface between the dispensing device and lower tile prevents fluids from flowing or otherwise getting behind the panels, thereby maintaining improved sanitary conditions for the overall assembly.

In operation, a user opens the panel 32, or in one embodiment also opens a cover panel 80, to the loading position. The user then loads a plurality of containers 42, 44, 46 in the holder 54 corresponding to the plurality of ports 34, 36, 38 in the panel, with each container holding a plurality of medical gloves 68, 70, 72.

Each of the plurality of containers holds a different size glove as compared with the other containers in the holder. Each of the containers is biased toward the rear surface of the panel by the biasing member 66. The plurality of containers 68, 70, 72 are positioned in the holder such that they are aligned respectively with the ports 34, 36, 38 of corresponding sizes. For example, a container 42 of small gloves 68 is disposed behind the port 34 having the smallest size, a container 44 of medium gloves 70 is disposed behind the port 36 have an intermediate size and a container 46 of large gloves 72 is disposed behind the port 38 having the largest size. It should be understood that the device may be configured with only two ports of comparative size, or if the gloves are provided in more than three sizes, the device may be provided with a corresponding number of port and storage spaces. Of course, it should be understood that the holder may provide storage space for other containers that are not aligned with a respective port.

After the containers 68, 70, 72 are appropriately loaded, the user moves the panels 32, 80 to a dispensing/closed position, and if appropriately configured and desired, locks the panel or panels. When needed, a healthcare provider opens the cover 80, or approaches the dispensing device. The healthcare provider views the ports 34, 36, 38, and relying on the indicia provided by the size thereof, selects a medical glove of appropriate size for the task at hand by grasping a glove or gloves and extracting the glove or gloves through the selected port 34, 36, 38.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A medical glove dispensing device comprising:
a panel having a plurality of differently sized ports, wherein each of said ports is sized to provide indicia about a size of a medical glove adapted to be disposed behind and dispensed through the port; and
a holder disposed adjacent said panel, wherein said holder provides a plurality of storage spaces sized and adapted to support a plurality of medical glove containers holding differently sized medical gloves, wherein said plurality of storage spaces are aligned respectively with said plurality of said ports, and wherein each of said storage spaces has substantially the same width.

2. The medical glove dispensing device of claim 1 wherein each of said plurality of ports has a different height and a horizontal centerline, wherein said centerlines of said plurality of ports are aligned along a horizontal axis.

3. The medical glove dispensing device of claim 2 wherein said plurality of ports each have the same shape.

4. The medical glove dispensing device of claim 3 wherein said ports each have an obround shape.

5. The medical glove dispensing device of claim 1 wherein said plurality of ports comprises at least three ports, and wherein each of said ports has a vertical axis extending along a centerline of each of ports, wherein said vertical axes are spaced equidistance relative to each other.

6. The medical glove dispensing device of claim 1 wherein said holder comprises a shelf positioned beneath said plurality of ports.

7. The medical glove dispensing device of claim 6 wherein said holder comprises a rear wall member spaced from a surface of said panel.

8. The medical glove dispensing device of claim 7 further comprising a plurality of biasing members coupled to said rear wall, each of said plurality of biasing members aligned with one of said plurality of storage spaces, wherein said biasing members are adapted to bias one of the medical glove containers toward said panel.

9. The medical glove dispensing device of claim 9 wherein said plurality of biasing members comprise at least one leaf spring.

10. The medical glove dispensing device of claim 1 wherein said panel is moveable from a dispensing position, wherein said holder is positioned in a storage space and is not accessible to a user, to a loading position, wherein said holder is removed from said storage space and is accessible to a user.

11. The medical glove dispensing device further comprising a lock actuatable between a locked position wherein said lock locks said panel in said dispensing position, and an unlocked position wherein said panel is moveable to said loading position.

12. The medical glove dispensing device of claim 1 further comprising a second panel moveable from an open position wherein said plurality of ports are exposed to a user for dispensing medical gloves and a closed position wherein said second panel covers said plurality of ports.

13. A medical glove dispensing assembly comprising:
a plurality of medical glove containers each holding a plurality of medical gloves, wherein each of said plurality of said medical glove containers holds a different size medical glove, and wherein each of said plurality of medical glove containers has an opening through which said medical gloves are dispensed;
a holder providing a plurality of storage spaces sized to support said plurality of medical glove containers, wherein each of said plurality of storage spaces have substantially the same width, and wherein said plurality of said medical glove containers are disposed in said plurality of storage spaces; and
a panel having a plurality of differently sized ports, wherein said panel is positioned adjacent said holder such that said plurality of storage spaces and said openings of said plurality of medical glove containers are aligned respectively with said plurality of said ports, wherein each of said ports is sized to provide indicia about the size of said medical glove in said medical glove container positioned behind said port.

14. The medical glove dispensing assembly of claim 13 wherein each of said plurality of ports has a different height and a horizontal centerline, wherein said centerlines of said plurality of ports are aligned along a horizontal axis.

15. The medical glove dispensing assembly of claim 14 wherein said plurality of ports each have the same shape.

16. The medical glove dispensing assembly of claim 13 wherein said plurality of ports comprises at least three ports, and wherein each of said ports has a vertical axis extending along a centerline of each of ports, wherein said vertical axes are spaced equidistance relative to each other.

17. The medical glove dispensing assembly of claim 13 wherein said holder comprises a shelf positioned beneath said plurality of ports and a rear wall member spaced from a rear surface of said panel.

18. The medical glove dispensing assembly of claim 17 further comprising a plurality of springs coupled to said rear wall, each of said plurality of springs aligned with one of said plurality of storage spaces, wherein said springs bias respective ones of said medical glove containers toward said panel.

19. The medical glove dispensing assembly of claim 18 wherein said plurality of springs comprise at least one leaf spring.

20. The medical glove dispensing assembly of claim 13 wherein said panel is moveable from a dispensing position, wherein said holder is positioned in a storage space and is not accessible to a user, to a loading position, wherein said holder is removed from said storage space and is accessible to a user.

21. The medical glove dispensing assembly of claim 13 further comprising a second panel moveable from an open position wherein said plurality of ports are exposed to a user for dispensing medical gloves and a closed position wherein said second panel covers said plurality of ports.

22. The medical glove dispensing assembly of claim 13 further comprising a mounting panel spaced from said panel with said holder positioned therebetween and a lower tile positioned below said mounting panel, wherein said mounting panel comprises a lower edge having a forwardly and downwardly extending bottom surface and said lower tile has an upper edge mating with said lower edge, said upper edge having a forwardly and downwardly extending upper surface.

23. A method of dispensing medical gloves comprising:
positioning a plurality of medical glove containers in a plurality of storage spaces provided by a holder behind a panel, wherein said plurality of storage spaces each have substantially the same width, wherein each of said plurality of medical glove containers holds a plurality of medical gloves, wherein each of said plurality of said medical glove containers holds a different size medical glove, and wherein said panel comprises a plurality of differently sized ports aligned respectively with said plurality of storage spaces, wherein each of said ports is sized to provide indicia about the size of said medical glove in said medical glove container positioned behind said port; and
dispensing a medical glove from one of said plurality of medical glove containers through said port aligned with said medical glove container positioned in said storage space aligned with said port.

24. The method of claim 23 wherein each of said plurality of ports has a different height and a horizontal centerline, wherein said centerlines of said plurality of ports are aligned along a horizontal axis.

25. The method of claim 23 wherein said plurality of ports each have the same shape.

26. The method of claim 23 wherein said plurality of ports comprises at least three ports, and wherein each of said ports has a vertical axis extending along a centerline of each of ports, wherein said vertical axes are spaced equidistance relative to each other.

27. The method of claim 23 further comprising biasing said plurality of containers towards said panel.

28. The method of claim 23 further comprising moving said panel from a dispensing position, wherein said holder is positioned in a storage space and is not accessible to a user, to a loading position, wherein said holder is removed from said storage space and is accessible to a user, and replacing an empty one of said plurality of medical glove containers with a full medical glove container when said panel is in said loading position.

29. The method of claim 28 further comprising locking said panel in said dispensing position.

30. The method of claim 23 further comprising covering said plurality of ports with a second panel, and moving said second panel to an open position wherein said plurality of ports are accessible for dispensing said medical gloves.
